(19) United States
(12) Patent Application Publication
(10) Pub. No.: US 2014/0039959 A1
(43) Pub. Date: Feb. 6, 2014

(54) COMPUTERIZED COMPLIANCE MANAGEMENT SYSTEM

(71) Applicants: Mary Joan Clarke, Blisworth (GB); Matthew Charles Russell, Cranfield (GB); Andrew Bateman, Huntington (GB)

(72) Inventors: Mary Joan Clarke, Blisworth (GB); Matthew Charles Russell, Cranfield (GB); Andrew Bateman, Huntington (GB)

(21) Appl. No.: 13/900,938

(22) Filed: May 23, 2013

Related U.S. Application Data
(60) Provisional application No. 61/651,764, filed on May 25, 2012.

(51) Int. Cl. G06Q 10/06

(52) U.S. Cl. CPC G06Q 10/06398
USPC 705/7.15; 705/7.42

(57) ABSTRACT

A computerized compliance management system or a computerized competency/compliance management system that facilitates the planning, management, administration and taking of assessments and delivers the results of the assessment with reference to relevant competencies for members or people working in teams or groups and particularly those working in teams or groups for large organisations.

The present invention relates to a computerized compliance management system. Various features forming part of a computerized compliance management system are described including a computerized message display, a computerized message system, a display for a computerized compliance management system, an electronic compliance management storage system, and a computerized compliance management monitoring system and methods and computer readable media thereof.

Described examples relate to a compliance management system or a competency/compliance management system and methods and computer readable media thereof that facilitate the planning, management, administration and taking of assessments for members or people working in teams or groups and particularly those working in teams or groups for large organisations as parts of computerized competency/compliance management system. Described examples provide a single portal that empowers managers of those teams within a computerized competency/compliance management process that provides access to learning materials and resources for assessed individual members of their team.

### BACKGROUND OF THE INVENTION

Organisations strive to have the best workforce working for them. This involves ensuring that their employees have appropriate skills and are informed about and have understood all aspects of their jobs. Typically, particularly in large organisations, people work in teams or groups with each team having a different role and each member of a team having a particular role within a team. Typically, each team is managed by a team manager. Organisations wish to know that each team is operating effectively and each team's manager wishes to know that each member of his or her team is operating effectively in order to reduce the risk in mistakes being made.

Some current computerized arrangements such as Cognisco (the assignee of the present application) “Milestone” and “Reveal” products have a heavy reliance on vendor support in order for managers to understand risk within their team. This results in a significant ongoing support costs for organisations using these systems.

There is thus a need to empower team managers with a computerized competency/compliance management system that, in particular, allows them to understand risk within their team, but also for individual members within the group to be more aware of their progress in completing assessments and acquiring the knowledge necessary to successfully complete assessments. In this way, staff motivation and performance is improved; there is reduced frequency and severity of incidents and accidents; business performance is improved; learning and development costs are reduced; and solutions for assessors are simplified.

### BRIEF SUMMARY OF THE INVENTION

The invention in its various aspects is defined in the independent claims below to which reference should now be made. Advantageous features are set forth in the dependent claims.

Arrangements are described in more detail below and take the form of a computerized compliance management system or a computerized competency/compliance management system that facilitates the planning, management, administration and taking of assessments and delivers the results of the assessment with reference to relevant competencies for members or people working in teams or groups and particularly those working in teams or groups for large organisations.

Generally, arrangements described herein provide various aspects of an improved computerized competency/compliance management system.

There are many factors involved in achieving an improved computerized competency/compliance management system as set-out below including storage of assessment-related data; targeting of assessments both as teams as a whole and as individuals within a team; and in monitoring the distribution of information and particularly safety-critical information.

Currently, assessment-related data is either not stored electronically or it is stored on various disparate systems. Embodiments of the present invention provide a flexible content storage system for assessment-rated data that readily allows users to access the information they need to monitor performance of teams and team members.

Different teams and different team members need to know different things and to different levels of understanding. Embodiments of the present invention allow information or media to be targeted appropriately.

Once information or media have been targeted, embodiments of the present invention ensure that it is monitored and, in particular, that it has been received and understood by the intended recipient.

In an aspect of the present invention, there is provided a computerized message display configured to display messages received by a member of a group comprising: a plurality of message titles arranged such that when any of the message titles are selected a message associated with the selected message title is displayed next to the title.

The message titles may be arranged vertically relative to the display. The message titles may be arranged such that when any of the message titles are selected a message associated with the selected message title is displayed below the title. The message titles may be displayed on a background with a different appearance to the background of the message associated with the selected message title. Adjacent each message title may be an indication of the status of the message associated with the title. The indication may comprise an indication of one or more from the following: urgency of the message, whether the message has been selected, whether the message is currently selected. Adjacent each message title may be an indication of when the message was sent. Each message may comprise an indication of when the message was sent. Each message may comprise an indication of the message sender. A user may be requested to confirm that they have read and/or understood the message in response to input from the user. The input may comprise one or more of the following: the user selecting another message title, the user selecting a portion of the message being displayed, the user selecting another designated portion of the display. The message may comprise text and/or one or more images. The background of the message title may change when it is selected. The background of the message title may change to be substantially the same as the background of the message associated with it.

In another aspect of the present invention, there is provided a computerized message system arranged such that a user is requested to confirm that they have read and/or understood a displayed message by user input.

The user input may comprise one or more of the following: the user selecting a message title, the user selecting a portion of the displayed message, the user selecting a designated portion of a display.

In another aspect of the present invention, there is provided a display for a computerized compliance management system for assessing performance and/or progress of a group, the display comprising: an indicator comprising a plurality of selectable portions, each portion representing a predetermined range of performance and/or progress levels; the display being configured such that when one of the plurality of selectable portions is selected the display displays: an indication of identity of at least some members of the group within the range of the predetermined performance and/or progress level represented by the selectable discrete portion; and an indication of performance and/or progress of at least one activity carried out by each of the displayed at least some members of the group.

The display may be configured to show the most relevant information to a user first. Each of the plurality of selectable portions may have a size dependent on the number of members of the group within the range of the predetermined performance and/or progress level represented by the selectable discrete portion. Each of the plurality of selectable portions may have a different appearance. The different appearance may comprise a different color. The color of one selectable portion may comprise red. The color of one selectable portion may comprise green. The plurality of selectable portions may comprise three or more portions. The plurality of selectable portions may comprise three and only three portions. The indication of identity may comprise the name of the at least some members of the group. The indication of performance and/or progress of at least one activity carried out by each of the displayed at least some members of the group may comprise a graphic. The indication of performance and/or progress may comprise at least one from the following list: unknown or unsure; not started; incomplete; that a user is a risk; that a user requires additional training; that a user requires additional supervision; that assessment has been completed to a standard above that set.

In another aspect of the present invention, there is provided an electronic compliance management storage system comprising: a store arranged to store indications of compliance management information; and a store arranged to store tags; wherein each tag has assigned to it one or more of the indications of compliance management information.

The indications of compliance management information may comprise an address on the Internet. The indications of compliance management information may comprise an electronic file. Different tags may be assigned to the same indication of compliance management information.

In another aspect of the present invention, there is provided a computerized compliance management monitoring system for a group comprising members, wherein the monitoring system comprises: an entry for each member of the group; each entry comprising: an indication of one or more assessments assigned to each member; and an indication of status of the one or more assessments assigned to each member.

One or more members may access only their own entry, one or more members may access a predetermined set comprising one or more other members entries. Each entry may further comprise a profile including a user's personal data.

In another aspect of the present invention, there is provided a computerized compliance management system comprising one or more computers, the one or more computers being configured to provide: at least one learning and/or development module; at least one risk assessment; competency management; document management; compliance monitoring; and at least one employee survey.

In another aspect of the present invention, there is provided a computerized method of displaying messages received by a member of a group comprising: displaying a plurality of message titles on a computer display; a user selecting one of the plurality of message titles; and displaying a message associated with the selected message title next to the title on the computer display.

In another aspect of the present invention, there is provided a computerized method for a message system, the computerized method comprising: displaying a request for a user to confirm that they have read and/or understood a displayed message on a computer display; and a user inputting a confirmation that they have read and/or understood the displayed message.

In another aspect of the present invention, there is provided a computerized method for a computerized compliance management system for assessing performance and/or progress of a group, the computerized method comprising: displaying an indicator comprising a plurality of selectable portions on a computer display, each portion representing a predetermined range of performance and/or progress levels; a user selecting one of the plurality of selectable portions; displaying an indication of identity of at least some members of the group within the range of the predetermined performance and/or progress level represented by the one selected selectable portion on the computer display; and displaying an indication of performance and/or progress of at least one activity carried out by each of the displayed at least some members of the group on the computer display.

In another aspect of the present invention, there is provided an electronic compliance management storage method comprising: assigning, by use of a computer, a tag to one or more indications of compliance management information; and storing, in a store of a computer, the one or more indications of compliance management information in the store together with an indication of the tag assigned to it.

In another aspect of the present invention, there is provided a computerized compliance management monitoring method for a group comprising members, wherein the monitoring method comprises: a computer display displaying an entry for each member of the group; each entry comprising: an indication of one or more assessments assigned to each member; and an indication of status of the one or more assessments assigned to each member.

In another aspect of the present invention, there is provided a computerized method of managing compliance, the method comprising providing: at least one learning and/or development module; at least one risk assessment; competency management; document management; compliance monitoring; and at least one employee survey.

In another aspect of the present invention, there is provided a computer-readable medium containing a set of instructions that causes a computer to perform a method of displaying messages received by a member of a group, the method comprising: displaying a plurality of message titles on a computer display; a user selecting one of the plurality of message titles; and displaying a message associated with the selected message title next to the title on the computer display.

In another aspect of the present invention, there is provided a computer-readable medium containing a set of instructions that causes a computer to perform a method for a message system, the method comprising: displaying a request for a user to confirm that they have read and/or understood a displayed message on a computer display; and a user inputting a confirmation that they have read and/or understood the displayed message.

In another aspect of the present invention, there is provided a computer-readable medium containing a set of instructions that causes a computer to perform a method for a computerized compliance management system for assessing performance and/or progress of a group, the method comprising: displaying an indicator comprising a plurality of selectable portions on a computer display, each portion representing a predetermined range of performance and/or progress levels; a user selecting one of the plurality of selectable portions; displaying an indication of identity of at least some members of the group within the range of the predetermined performance and/or progress level represented by the one selected selectable portion on the computer display; and displaying an indication of performance and/or progress of at least one activity carried out by each of the displayed at least some members of the group on the computer display.

In another aspect of the present invention, there is provided a computer-readable medium containing a set of instructions that causes a computer to perform a method comprising: assigning, by use of a computer, a tag to one or more indications of compliance management information; and storing, in a store of a computer, the one or more indications of compliance management information in the store together with an indication of the tag assigned to it.

In another aspect of the present invention, there is provided a computer-readable medium containing a set of instructions that causes a computer to perform a method on a computerized compliance management monitoring system for a group comprising members, wherein the method comprises: a computer display displaying an entry for each member of the group; each entry comprising: an indication of one or more assessments assigned to each member; and an indication of status of the one or more assessments assigned to each member.

In another aspect of the present invention, there is provided a computer-readable medium containing a set of instructions that causes a computer to perform a method comprising providing: at least one learning and/or development module; at least one risk assessment; competency management; document management; compliance monitoring; and at least one employee survey.

Embodiments of the present invention provide corporate entities and individual users with an excellent competency management solution. Aspects of the solution may be combined to address regulated and non-regulated industries.

Embodiments of the present invention provide a structured risk based approach to developing standards of competency and then uses these standards to assess competence and through guided interventions, and enhances an individual's ability to achieve their full potential.

Embodiments of the present invention improve staff and business performance, as well as reduce risks and the potential for human error.

Embodiments of the present invention reduce administrative burden which many compliance or learning and development officers experience as they attempt to mitigate and control real risks in an organisation.

Embodiments of the present invention may be tailored for sector specific regulated companies, regulators, educational establishments and professional bodies for a good competency/compliance management solution (CMS).

Embodiments of the present invention improve the competence of an entire workforce. Embodiments of the present invention are able to improve the overall ability and attitude of employees.

Embodiments of the present invention assess the ability, attitude and overall confidence of employees against structured risk based competence standards. This provides evidence of a compliant workforce. Embodiments of the present invention enable the assessment and management of the performance of an organization's workforce and delivers compliance/'fitness to practice' together in one place.

Embodiments of the present invention allow companies and other organizations to assess, manage and develop their people and their associated business activities. The resulting human capital business intelligence may influence recruitment decisions, talent management, risk management and succession planning. Having this information may improve operational and organisational efficiency and deliver significant business cost savings.

Embodiments of the present invention bring together or integrate at least some of intelligent employee assessments, as well as learning and development modules, risk assessments with alerts, competency management, document management, compliance monitoring and employee surveys in one system. Using the system, employees may take scenario-based assessments that measure their knowledge and confidence in performing their duties. The results then give a complete insight into their performance, their specific training, mentoring or coaching needs and details of weak areas that must be addressed immediately. The proposed interventions once implemented may help: employees realise their full potential; and improve or even optimise workforce efficiency.

Embodiments of the present invention provide reporting that provides an holistic view of an entire workforce at a glance so that the right decisions may be made about how to get the best from employees and improve the overall business performance.

Embodiments of the present invention provide one or more of: easy identification of key talent in an organization; easy assessment and measurement of individual knowledge, performance and/or confidence; identification of targeted training interventions to enhance performance; monitoring of improved business efficiency through targeted training interventions; transparency of competency standards throughout the organization; optimization of employee performance standards; improved employee relations through clearer communications; clearer information about employees' competency progression; a simplified competency/compliance monitoring solution for every member of the organisation

Embodiments of the present invention assure that a workforce is appropriately skilled, trained and competent in their positions within an organisation.

Embodiments of the present invention provide a comprehensive competency management system for businesses.

Embodiments of the present invention provide a systematic approach for an organisation to take to ensure its collective competence covering the assessment and training of current employees as well as recruitment and succession planning.

Embodiments of the present invention allow an organization's competency management system to consider all of an organisation's requirements. These include not just licensing and regulatory requirements but also those relative to the wider business environment. To support regulatory requirements it is important to maintain and demonstrate a competent organisation which is able to operate in a safe manner. However from a business perspective the organisation should also maintain a competent workforce to ensure that:

the quality of its product or service meets both its standards and that of its customers; and the operation and management of business is such that it meets its financial objectives.

Embodiments of the present invention enable organisations which operate in a highly regulated, safety focused industry to determine the safe operations of its facilities by building the competence of the people that use, maintain and manage them. Historically there have been several major incidents which have revealed that staff lacked important safety knowledge and skills despite having received training.

Embodiments of the present invention assure that competence may be demonstrated and assessed rather than assumed, based on part training, coaching, mentoring and experience.

Factors contributing to a person's competence include their prior experience, attitudes, skills and qualifications.

Embodiments of the present invention may be fully integrated within an organization so that it can address compliance issues, improve business performance and protect the health and safety of its employees, suppliers, contractors, customers and the general public. Developing competence is not in itself a guarantee of safety, but it will help reduce the risks to levels that are as low as reasonably practicable.

People may be currently competent but they do not necessarily retain a satisfactory level of competence over time without periodic application of the competence supported by formal training, on the job training/coaching or appropriate refresher training especially where such skills cannot be practical or routinely tested, i.e. in emergency response situations.

Embodiments of the present invention help define the roles and associated responsibilities of those operating in the computerized competency management system described herein and ensure that they are understood by the post holders.

Embodiments of the present invention enable the management of an organisation. They give managers the ability to manage and assess skills, experience, knowledge, attitude, qualifications and training. Embodiments of the present invention provide a database that may record the competencies of a person matched to the tasks they are required to perform.

The benefits of the competency management feature of embodiments of the present invention include: facilitation of a gap analysis to identify further training and provide input to establish a training budget in a more systematic way than simply using the previous year's budget with an increase for inflation; pursuit of a clear documentation of compliance with any legislative requirements; an ability to undertake tactical resourcing decisions and consider strategic HR planning such as succession planning, demographic profiling and identification of recruitment requirements; an ability to identify a better match between training needs and their provision; opportunities to identify cost and time savings through economies of scale and more effective use of staff resources; ability to draw upon the flexibility and transferability of skilled staff across different business units; a demonstrable and auditable approach for matching agreed competency levels with assessed actuals and resulting training outcomes.

Embodiments of the present invention may identify the competencies needed for the roles/tasks undertaken and describes each competency in a usable form that enables an assessment to be performed.

Within the highly regulated process industries such as nuclear, oil, gas, chemical processing, healthcare and transportation all key tasks that contribute to personal or environmental safety are usually subjected to some form of task analysis across the organisation and assessed against a set of predetermined performance standards.

Embodiments of the present invention provide a communications facility which is crucial for the effective operations of the system. Embodiments of the present invention provide for special communications channels for all staff including auditors and those not directly employed by the organisation such as its subcontractors and third party regulators.

Embodiments of the present invention provide a competency management facility supported by a competency framework which typically consists of three levels. The first level covers competency categories, which lead to a second level of competency groupings within each category. The final tier covers specific competencies and is where the performance criteria are identified. The competency framework may be supported by an appropriate skills assessment and training requirements database.

The competency framework may reflect both the industry and business objectives. Where the first tier competency categories include human factors, then the second tier group may include: communication skills; people management; customer service skills; team skills; leadership/decision making skills; problem solving; performance management; and technical skills.

Embodiments of the present invention enable the skills and knowledge needed to perform certain roles and tasks to be identified. These competencies may be assessed to demonstrate the level of a person's competence for each area that they are required to perform. This may follow a three step process covering: the identification of the competencies needed for a role or task; a performance standard for each competency; and assessment of the role holder.

Embodiments of the present invention ensure that the competency and training management system functions are correctly monitored for effectiveness by examining: qualitative performance indicators from the performance standards and the identified roles;

quantitative measures with respect to compliance of assessed competency against company set targets; competency database outputs of information on the trainees; data from incidents and audits to identify training related problems; and mapped to national and international occupational competencies so benchmarking may be carried out.

Monitoring performance against agreed key assessment criteria lies at the heart of monitoring and developing standards of competence. Planned re-assessments of competency and consistent performance may be checked by a supervisor or manager. The frequency and sophistication of the monitoring should relate to the risks within the task being undertaken.

Embodiments of the present invention may provide appropriately skilled and more motivated personnel, reduce waste, increase shareholder value, demonstrate compliance with regulatory requirements and thus contribute to business success.

### BRIEF DESCRIPTION OF THE DRAWINGS

The invention will be described in more detail, by way of example, with reference to the accompanying drawings, in which:

FIG. 1 is a schematic diagram of a computer system including computer terminals embodying an aspect of the present invention; and

FIGS. 2 to 15 are views of the screen of a computer terminal of the computer system of FIG. 1.

### DETAILED DESCRIPTION OF THE INVENTION

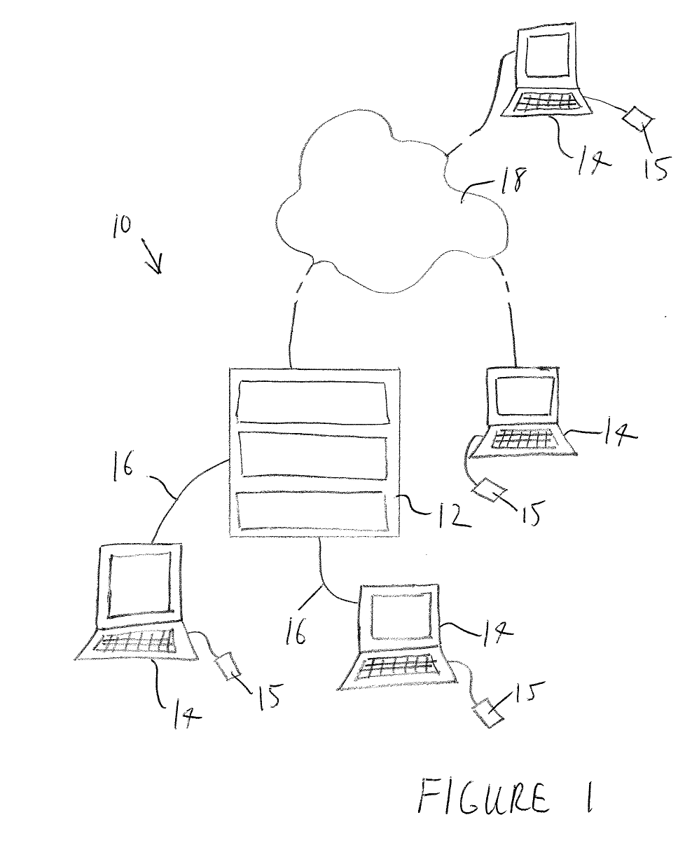

An example compliance management system or a competency/compliance management system 10 will now be described with reference to FIGS. 1 to 15. The system is typically for use by large enterprises such as companies or governmental organisations employing hundreds of people or more. It may be used by people with different roles within the organisation to support them in their role. These include a delegate (an individual or person being assessed), a team manager (a line manager responsible for a number of delegates or, in other words, a group of delegates or members), a content provider (a person who provides and manages learning and assessment resources for the organisation), and an administrator (a person responsible for support and maintenance of the system). Users can exist or use the system in one or more of these roles. That is to say, the roles are not always mutually exclusive (for example, a delegate can also be a team manager and an administrator, but not a content provider).

As illustrated in FIG. 1, the computerized compliance management system 10 includes a server 12 to which are connected, via a communication connection, a plurality of computer terminals 14. Each computer terminal includes a display such as a liquid crystal display monitor. Computer terminals are shown as desktop computers. However, they may be other devices, such as, for example, laptop computers, smart phones, or tablet computers. The computer terminals each include a pointing device, in this example, a mouse 15, to allow a user to select items displayed on the display. Alternatively, a user may select items on the display by one or more other devices, such as using a touch-sensitive screen of the display or using a trackball or other pointing device. Some of the computer terminals are connected to the server via an ethernet or local area network connection 16. Some of the computer terminals are connected to the server via the Internet 18. Other communication connections to the server are possible. A computer-readable medium, such as a CD-ROM, DVD-ROM or solid state memory device, such as a USB memory device may be provided containing a set of instructions that causes a computer or computers on a network to perform the method described below.

The computerized compliance management system 10 may be implemented over the internet. It may be implemented as a cloud computing application, in which users access the computerized compliance management system through a web browser or application on a computer, for example, a desktop computer, laptop computer, smart phone, or tablet computer while the software and data for implementing the computerized compliance management system are stored on one or more computers or one or more servers at a remote location. The computerized compliance management system 10 may also be implemented as an “offline” solution where a user enters data when they are not connected to the computerized compliance management system 10 on a computer, for example, a desktop computer, laptop computer, smart phone, or tablet computer and the data is automatically (or manually) uploaded to the system when the computer is connected to it.

Generally, the compliance management system enables the features described by way of a user interface (UI) or graphical user interface on the displays of the computer terminals, in which each section is included in a separate “tab”.

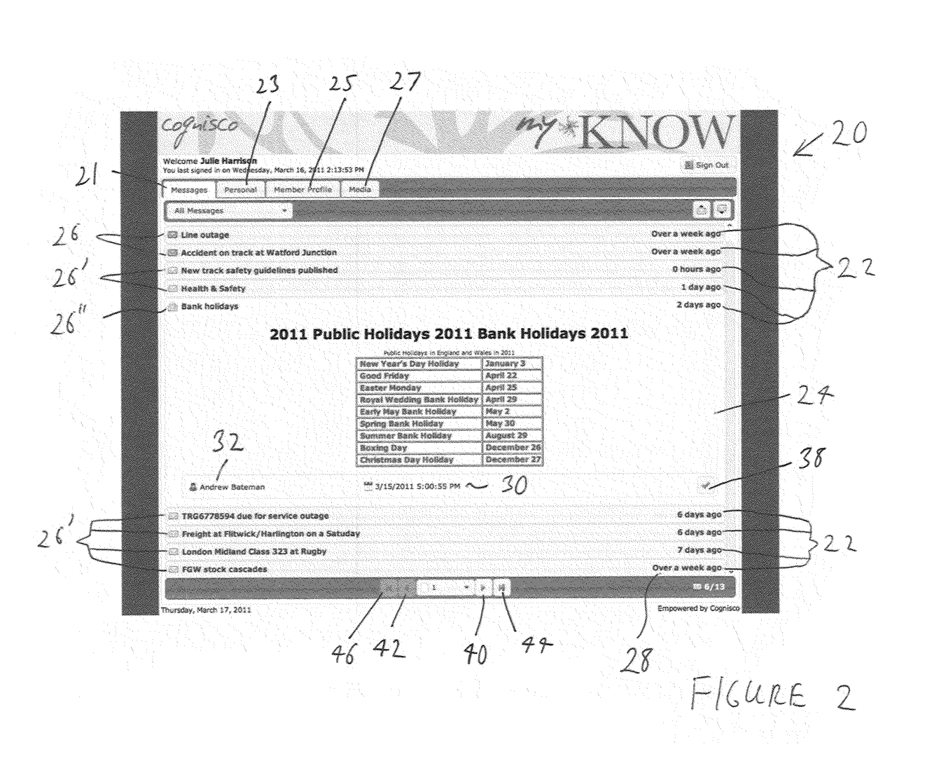

The examples of FIGS. 2 to 6 are for a non-manager user. It has tabs including: messages 21, personal 23, member profile 25 and media 27. Each tab is pressed or selected to display different functionality. The functionality given in the messages tab and personal tab are described below with reference to FIGS. 2 to 4 and FIGS. 5 and 6 respectively.

As illustrated in FIG. 2, one feature is a display of a computer terminal or a computerized message display 20 that is configured to display messages or alerts received by a member or a delegate of a group as part of a computerized compliance management system. This display appears when the messages tab 21 is selected. When the messages tab is selected, a plurality of message titles 22 are displayed. The message titles are arranged such that when any of the message titles are selected a message 24 associated with the selected message title is displayed next to the title and, in particular directly or immediately next to the title; they abut one another. In this example, the selected message below the title and, in particular, directly or immediately below the title. One and only one message is displayed at once or at the same time. In this example, the message titles are arranged vertically relative to the display. The message titles are displayed on a background with a different appearance to the background of the message associated with the selected message title, in this example, a different color. The background of the message title changes when it is selected, in this example, to the same background of the message associated with it.

Adjacent each message title 22 is an indication, symbol or icon 26, 26′, 26″ of the status of the message associated with the title. The indication reflects, for example, the urgency of the message or alert (urgent messages or alerts 26 are indicated by a symbol in one color for example, an envelope that, in this example is red, non-urgent messages 26′ are indicated by the same symbol, but in a different color, in this example blue), whether the message has been selected, whether the message is currently selected (open or selected messages are indicated by one symbol, in this example, an open envelope 26″, unselected messages are indicated by another, but related symbol, in this example a sealed or closed envelope 26′).

Adjacent each message title 22 is an indication 28 of when the message was sent. In this example, the title and the indication 28 of when the message was sent are in the same header or band. The indication 28 of when the message was sent is approximate and with a big and varying level or granularity depending on how long ago the message was sent. If the message was sent within the last 24 hours, then the whole number of hours since the message was sent is displayed, if the message was sent more than 24 hours ago, but a week or less ago, then the whole number of days since the message was sent is displayed. If the message was sent over a week ago, then the same time indication is displayed independent of the time the message was sent, in this example “over a week ago” is displayed.

The message 24 (as well as the message title described above) also includes an indication 30 of when the message was sent. This indication or time the message was sent is shown at a much smaller level of granularity than the indication 28 in the message title. In this example, the indication 30 includes the date and time in hours, minutes and seconds.

The displayed message 24 has an indication 32 of the name of the message sender, in this example, “Andrew Bateman”.

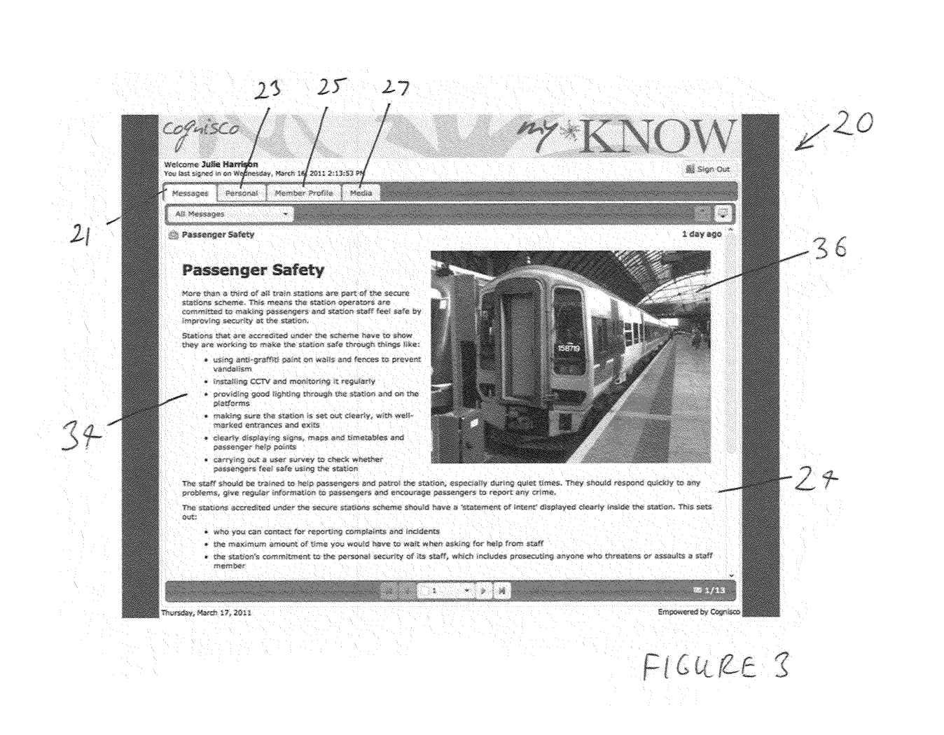

Displayed messages 24 may by rich messages including text 34 and/or one or more images 36 as illustrated in FIG. 3.

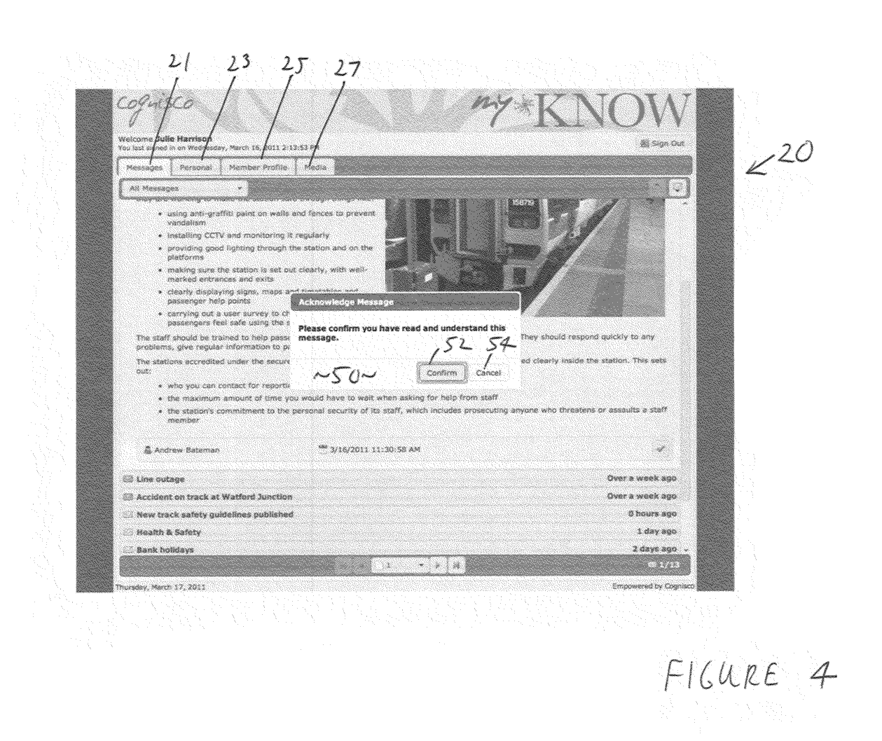

The message 24 also includes an arrangement for a user to confirm that they have read the message. As illustrated in FIG. 2, this takes the form of a representation of a button 38 that, in this example, is located next to or beside the indication 30 of when the message was sent. The button includes a tick and, in this example, a green tick. It is located at the end or after the message being displayed. When a user selects the button or designated portion of the display or, in other words, makes a deliberate click action on a specific part of the screen, as illustrated in FIG. 4, a window 50 appears in the display that requests the user, member or delegate to confirm that they have read and/or understood the message by user input. The window includes a pair of buttons 52, 54. One button, a confirmation button 52, for a user to input confirmation that they have read and/or understood the message and another button, a cancel button 54, for a user to input confirmation that they have not read and/or understood the message. The confirmation that a user has read and/or understood the message is made by the user selecting the confirmation button (displaying the word “Confirm”) using the mouse of their computer terminal. The confirmation that a user has not read and/or understood the message is made by the user selecting the cancel button (displaying the word “Cancel”) using the mouse of their computer terminal.

Once a user has confirmed that they have read and understood the message, an electrical signal indicting this is sent to the server where the user's confirmation is stored in a store (not shown).

As an alternative or in addition to the user input to cause the window 50 appearing being the user selecting a particular button 38 or designated portion of the display, the user input may be the user selecting another message title or the user selecting a portion of the message 24 being displayed.

Messages or alerts may be sent by a content provider to all individuals or to team managers from computer terminal 14. Messages or alerts may be sent by a team manager to all their team members from computer terminal 14.

Messages may be filtered. The message system may have paging capability in which a predetermined number or subset of a total number or set of messages are displayed on the display of the computer terminal at a time. In this example, nine messages are displayed out of total of thirteen messages. A user may page forward through the subset or pages of messages by selecting a button 40 on the user display 20, in this example, at the bottom of the display. A user may page back through the subset or pages of messages by selecting a button 42 on the user display 20 that, in this example, is near the forward button at the bottom of the display. This button is grayed out or cannot be selected in the example of FIG. 2 as the first subset of messages are displayed and so there is no message to page back to. A user may page to the last or first page of messages by selecting appropriate buttons 44,46 represented by barred arrows. The button 44 for moving to the first page is grayed out or cannot be selected in the example of FIG. 2 as the first subset of messages are displayed and so there is no message to page back to.

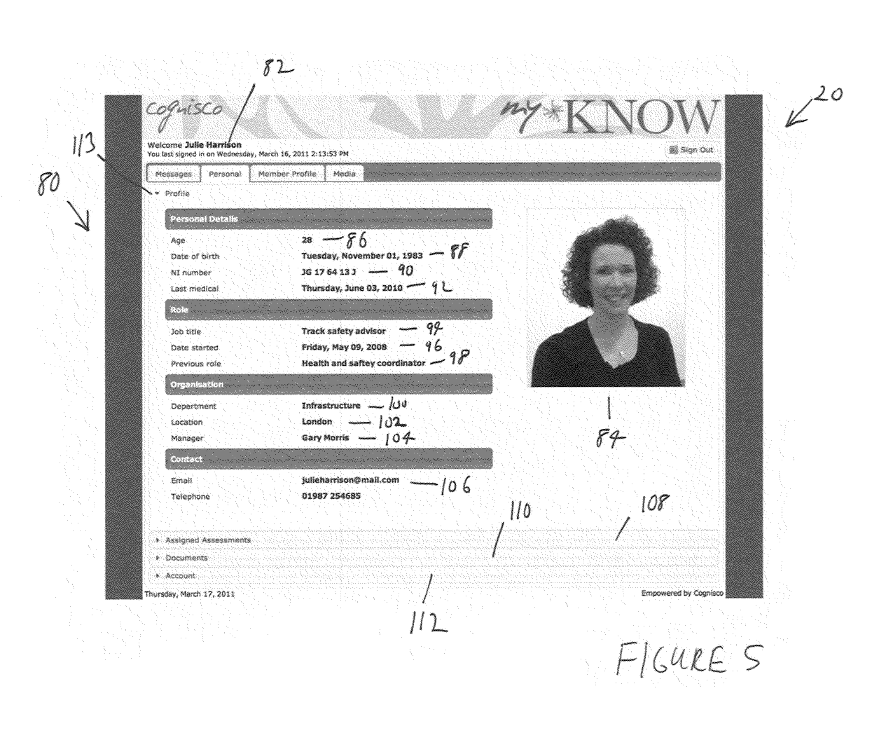

As illustrated in FIG. 5, the computerized compliance management system includes personal information 80 about each user or delegate, which may be viewed or displayed by the user on the display 20 of their computer terminal by selecting or pressing the personal tab 23.

The personal information that is displayed includes, in this example, a user's name 82, picture 84, age 86, date of birth 88, social security number or national insurance number (roughly, the UK alternative to a social security number) 90, time of their last medical examination 92, job title 94, start date 96, previous role or job title 98, department they work in 100, location 102, manager 104, and contact details including e-mail address and telephone number 106.

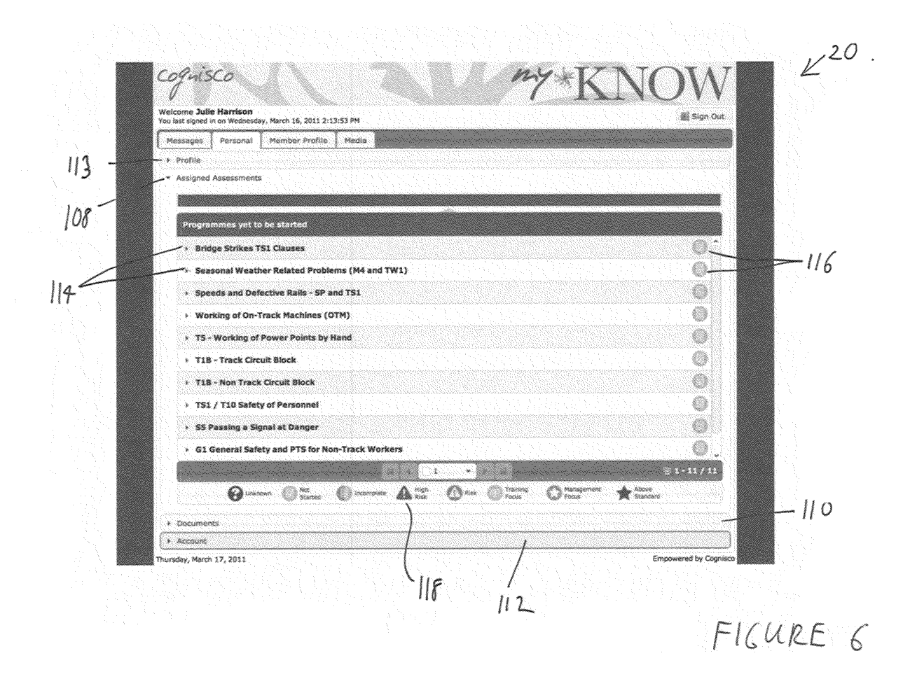

The personal information that is included also includes a list of assessments assigned to the user (viewed by selecting an “Assigned assessments” bar 108), this may include intelligent reports showing status and progress as well as program, module and topic level. FIG. 6 illustrates the display 20 after the assigned assessments bar has been selected. Once selected, the display displays the names of the assessments assigned to the particular user and beside each named assessment an indication of performance or graphic 116 the assessment or activity carried out by the user. The indication of performance may be that an activity is: unknown or unsure (if, for example, a “don't know” response has been used throughout a topic), not started; incomplete; that the user is a risk in which responses to assessment indicate that a user or team member misunderstands or is likely to act incorrectly in some key elements of their role; that response to assessment indicate that a user or team member may require some additional training (training focus);

that assessment indicates that a user or team member may require some additional supervision (management focus); or that the assessment has been completed to a standard above that set. The graphics or symbols representing the particular performance level are shown or displayed in form of a key 118. In this example, the user has yet to start any assessment programs and the symbol corresponding to this status is displayed next to each of the named assessments. A user may attach and view personal documents by selecting a documents bar 110. This allows a user to store assessment/learning related personal media, such as personal development plans. A user may also view personal documents that have been added by a team manager by selecting this bar. Administration of a user's account, for example changing a password, may be carried out by selecting an account bar 112. Favorite media may also be displayed on a user's terminal by selecting a favorite media bar (not shown) to allow a user to see media they have marked as a “favorite”. The display also includes a profile bar 113 to display the personal information illustrated in FIG. 5.

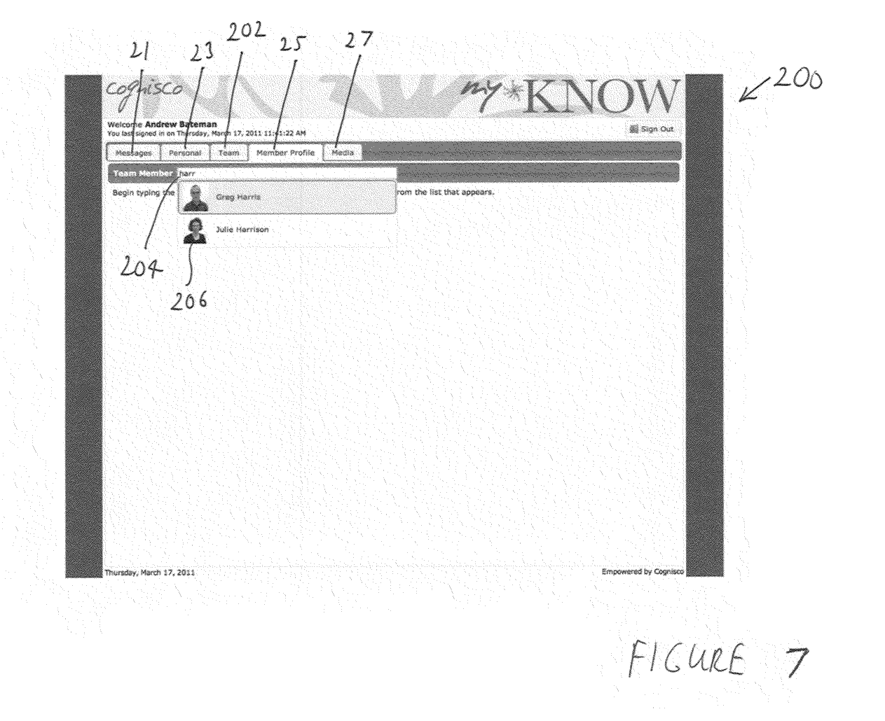

In the computerized compliance management system for a team or group, there is stored in a store, for example, on a hard disk drive or solid state memory, an entry for each member of the group including an indication of one or more assessments assigned to each member; and an indication of status of the one or more assessments assigned to each member. Each entry is a profile including a user's personal data. In the example of FIGS. 5 and 6, the team member may access only their own entry. FIGS. 7 to 13 illustrate a view on display 20 available to team managers.

In personal view described above with reference to FIGS. 5 and 6, a member of a team or an individual may access only their own entry. In team view, illustrated in FIGS. 7 to 13, a team manager may access a predetermined set of one or more other members of the stored data.

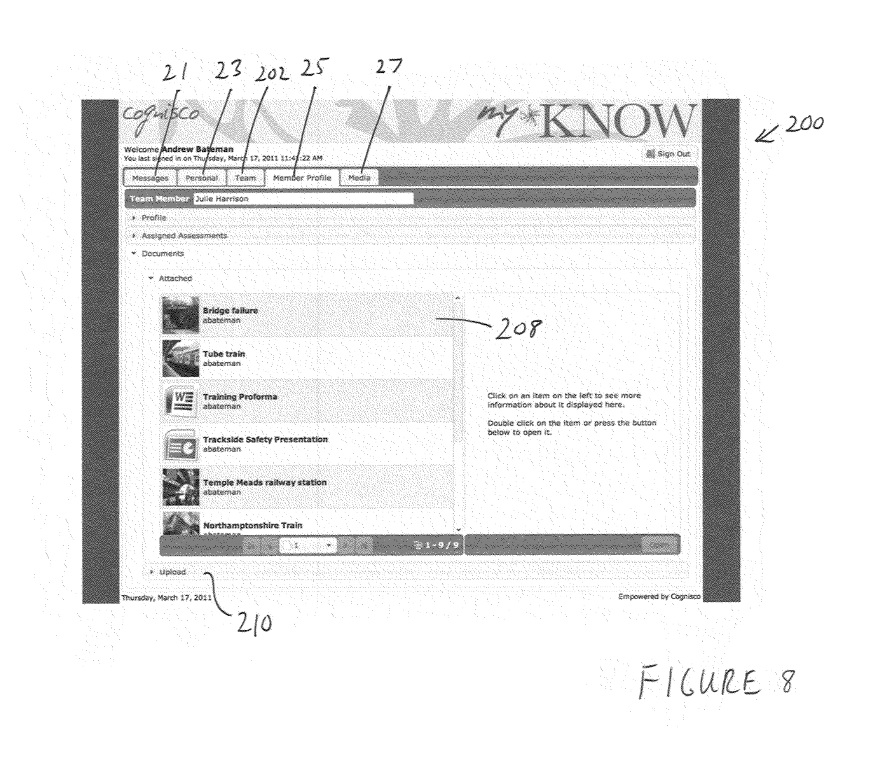

A team member profile is provided that is available to team managers only. It enables a team manager to view and edit team members' personal information; attach one or more personal documents to a team member's profile (illustrated in FIG. 8) so a manager can store assessment/learning related media that the delegate can then view; and to view team members' assessment performance.

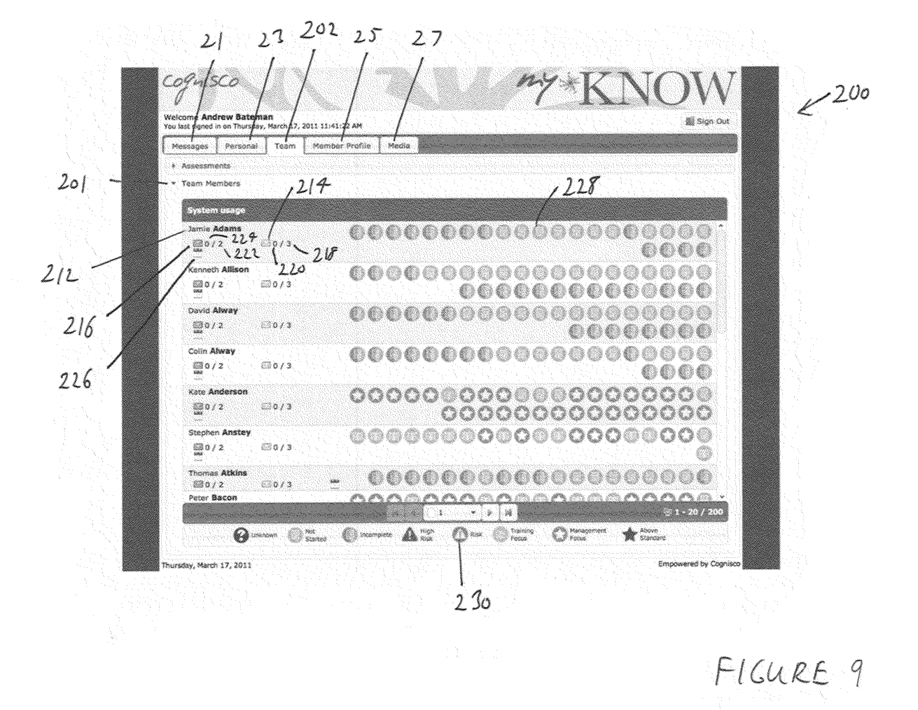

It enables a team manager to view members of their team's usage of the computerized compliance management system, for example, the number of messages and/or alerts received and/or acknowledged by each team member, the last login to the system of each team member, and each team member's results overview (illustrated in FIG. 9). Assessment progress and results may be reported for each team member.

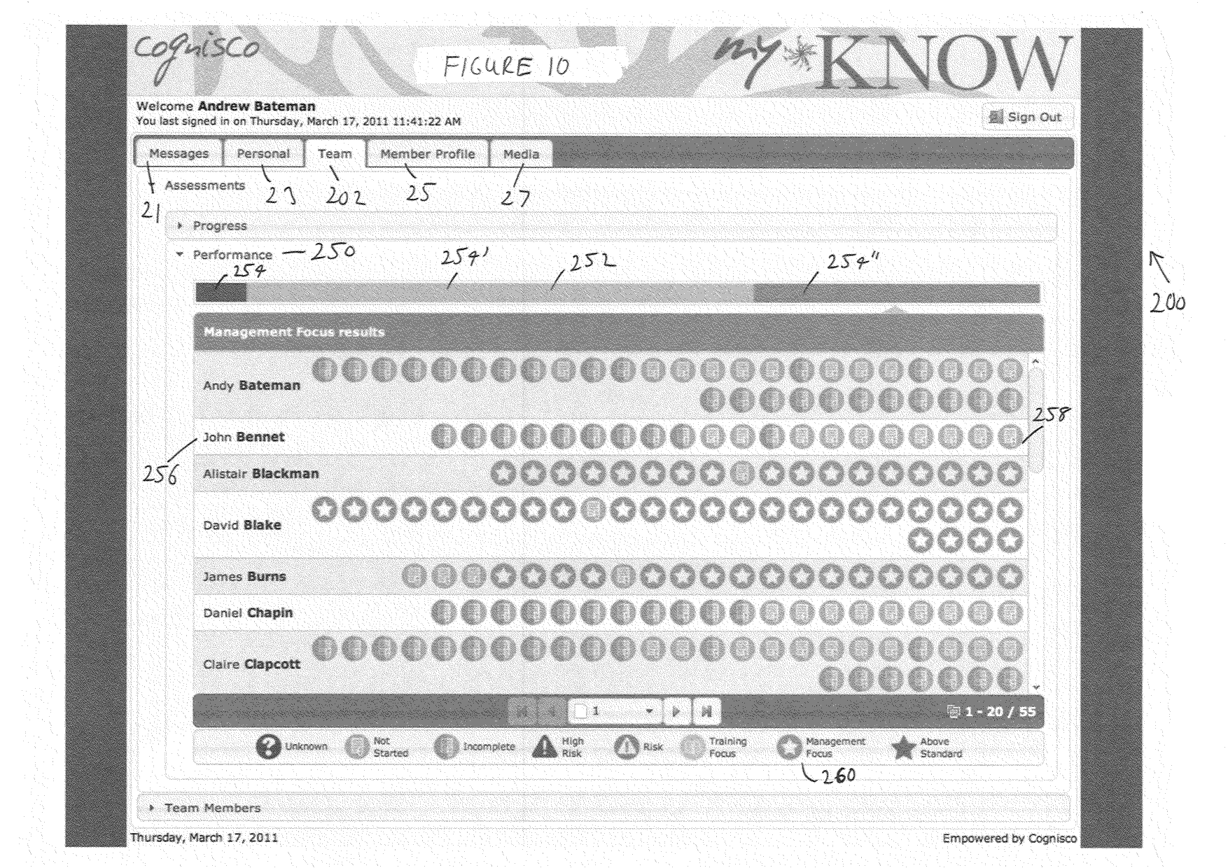

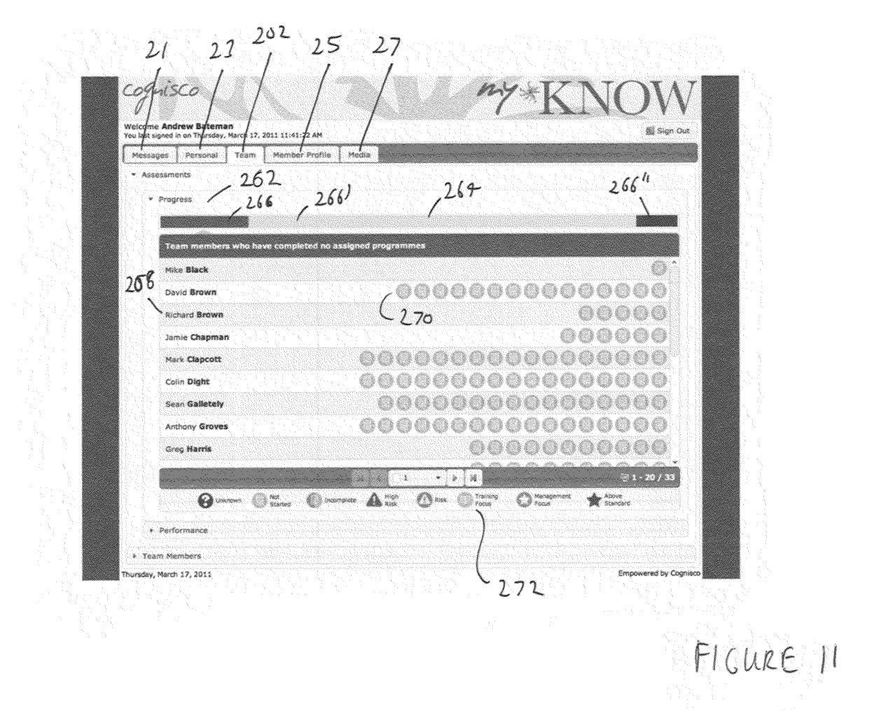

Also available to team managers only is a display content, illustrated in FIGS. 10 and 11, for the computerized compliance management system that allows team managers to assess the performance and/or progress of their group or team.

FIG. 7 illustrates a team manager's display 200. It includes the same tabs as the personal view (messages 21, personal 23, member profile 25 and media 27), but it additionally includes a team tab 202. In this example, the functionality of the member profile tab is illustrated. By selecting or pressing the member profile tab, a text box 204 appears on the display. A team manager may enter the name of the team member's information he wishes to view by entering their name in the box. Once a team manager starts entering name details into the box, possible names appear that in include the letters entered. So, in the example of FIG. 7, the words “harr” are entered and possible team members' names including these letters of “Greg Harris” and “Julie Harrison” (as well as pictures of these members 206) appear.

In this example, the team member “Julie Harrison” is selected by clicking her displayed name and her member profile as illustrated in FIG. 8 is displayed on the display 200. The displayed feature in FIG. 8 allows a team manager to view and attach one or more personal documents to a team member's profile. The display of FIG. 8 shows the documents 208 currently attached to a user's profile. Further documents may be attached by selecting the upload bar 210, which, in this example, is below the indication of the already attached documents 208.

FIG. 9 illustrates the functionality of the team tab 202. When the team tab is selected, the display 200 shows the view illustrated in FIG. 9 in which a team members bar 201 has been selected. By each team member's name 212, the number of messages and/or alerts received and/or acknowledged by each team member are displayed. The number of messages received 218 (in this example, three for all team members) and acknowledged 220 (in this example, zero for all team members) are displayed next to a symbol 214 of an envelope in one color (in this example, blue). The number of alerts received 222 (in this example, two for all team members) and acknowledged 224 (in this example, zero for all team members) are displayed next to a symbol 216 of an envelope in another color (in this example, red). The date of the last login to the system 226 of each team member is also displayed by each team member's name 212. Each team member's results overview is displayed beside the name of each team member. The results overview takes the form of an indication of performance or graphic 228 of each assessment or activity assigned to the particular user or team member. The indication of performance may be that an activity is:

unknown or unsure (if, for example, a “don't know” response has been used throughout a topic), not started; incomplete; that the user is a risk in which responses to assessment indicate that a user or team member misunderstands or is likely to act incorrectly in some key elements of their role; that response to assessment indicate that a user or team member may require some additional training (training focus); that assessment indicates that a user or team member may require some additional supervision (management focus); or that the assessment has been completed to a standard above that set. The graphics or symbols representing the particular performance level are shown or displayed in form of a key 230. Assessment progress and results are reported and are displayed for each team member.

As mentioned above, also available to team managers only is a display 200, illustrated in FIG. 10, for the computerized compliance management system that allows team managers to readily assess the performance of their group or team. This display appears when a performance bar 250 is selected. The display includes an indicator 252 comprising a plurality of selectable portions 254,254′,254″, each portion represents a predetermined range of performance levels. The display is configured such that when one of the plurality of selectable portions is selected the display displays: an indication of identity or name 256 of at least some members of the group within the range of the predetermined performance level represented by the selectable discrete portion; and an indication of performance or graphic 258 of at least one activity carried out by each of the displayed at least some members of the group. The indication of performance may be that an activity is: unknown or unsure (if, for example, a “don't know” response has been used throughout a topic), not started; incomplete; that the user is a risk in which responses to assessment indicate that a user or team member misunderstands or is likely to act incorrectly in some key elements of their role; that response to assessment indicate that a user or team member may require some additional training (training focus); that assessment indicates that a user or team member may require some additional supervision (management focus); or that the assessment has been completed to a standard above that set. The graphics or symbols representing the particular performance level are shown or displayed in form of a key 260.

Each of the plurality of selectable portions 254,254′,254″of the indicator 252 have a size dependent on the number of members of the group within the range of the predetermined performance level represented by the selectable discrete portion. Typically, there are three or more selectable portions. In this example, there are three and only three selectable portions. Each of the selectable portions has a different appearance, in this example, a different color. In this example, the colors are a “traffic light” arrangement such that one selectable portion is red, another is yellow, orange or amber and another is green. In this example, the red portion indicates danger or a warning as the predetermined performance level represents low performance, for example, a high predetermined number of not started assessments. The orange portion indicates satisfactory predetermined performance level, for example, a low predetermined number of not started assessments and incomplete assessments. The green portion indicates a good predetermined performance level, for example, a high predetermined number of completed assessments and a low predetermined number of incomplete assessments. In the example of FIG. 10, the green portion has been selected.

The example of FIG. 11, a feature of the computerized compliance management system is provided that allows team managers to readily assess the progress of their group or team. It appears on the display by selecting a progress bar 262 of the team tab 202. It is similar in most respects to the example of FIG. 10 and like features have been given like reference numerals except that the an indicator 264 comprising a plurality of selectable portions 266,266′,266″, each portion represents a predetermined range of progress levels. This example illustrates a feature that is also apparent in the example of FIG. 10, that the system is configured to show the most relevant information to a user first. The most relevant information is pushed to the top or displayed most prominently depending on who the user is (their role within the system). So, in this example, when the progress bar is selected, it first displays the team members who are performing worst; the team members who have made the least progress. The display is also configured such that when one of the plurality of selectable portions is selected the display displays: an indication of identity or name 268 of at least some members of the group within the range of the predetermined progress level represented by the selectable discrete portion; and an indication of progress or graphic 270 of at least one activity carried out by each of the displayed at least some members of the group. The indication of progress may be that an activity is: : unknown or unsure (if, for example, a “don't know' response has been used throughout a topic), not started; incomplete; that the user is a risk in which responses to assessment indicate that a user or team member misunderstands or is likely to act incorrectly in some key elements of their role; that response to assessment indicate that a user or team member may require some additional training (training focus); that assessment indicates that a user or team member may require some additional supervision (management focus); or that the assessment has been completed to a standard above that set.. The graphics or symbols representing the particular progress levels are shown or displayed in form of a key 272.

Each of the plurality of selectable portions 254,254′,254″of the indicator 252 have a size dependent on the number of members of the group within the range of the predetermined progress level represented by the selectable discrete portion. Typically, there are three or more selectable portions. In this example, there are three and only three selectable portions. Each of the selectable portions has a different appearance, in this example, a different color. In this example, the colors are a “traffic light” arrangement such that one selectable portion is red, another is yellow, orange or amber and another is green. In this example, the red portion indicates danger or a warning as the predetermined progress level represents low progress, for example, a high predetermined number of not started assessments. The orange portion indicates satisfactory predetermined progress level, for example, a low predetermined number of not started assessments and incomplete assessments. The green portion indicates a good predetermined progress level, for example, a high predetermined number of completed assessments and a low predetermined number of incomplete assessments. In the example of FIG. 11, the red portion has been selected.

This arrangement means that it is very easy for a manager to assess the performance and progress of members of their team so that appropriate action may be taken.

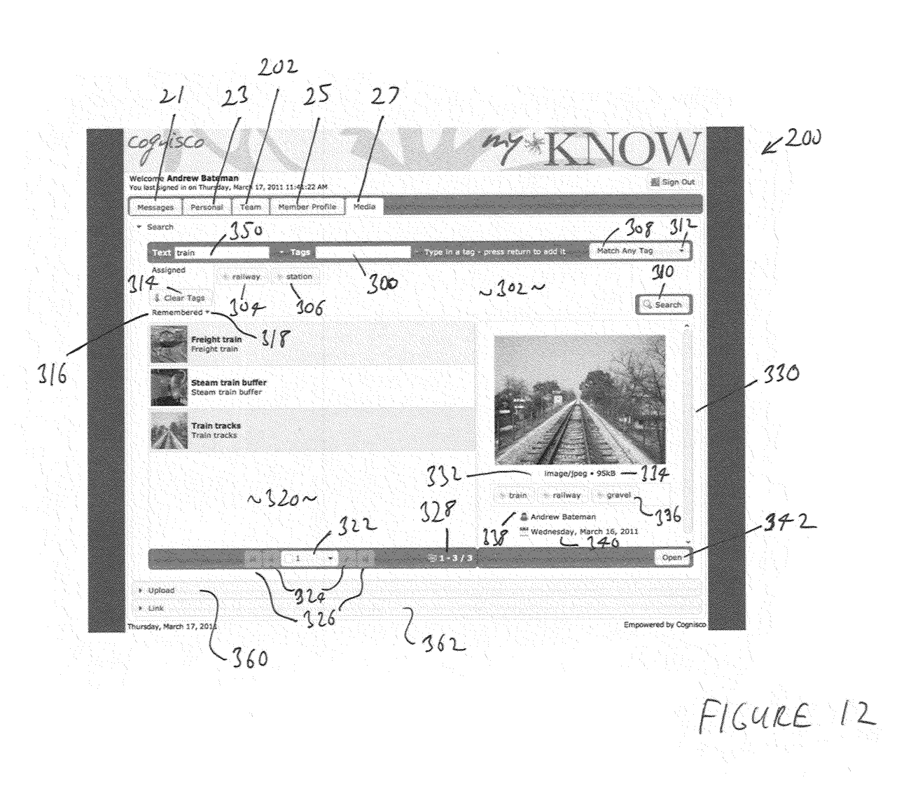

FIG. 12 illustrates a display of a user's or manager's terminal for an electronic compliance management storage system in which a store stores indications of compliance management information or assessment information, such as an address on the Internet (linked content) or an address on the electronic compliance management information storage system itself (stored content), for example, for information or data stored locally on a hard drive or other electronic storage medium. A store is also provided to store tags. Each of the stored tags has assigned to it one or more of the indications of compliance management or assessment information. This allows a user to readily retrieve the information stored at the address, such as an image or text information regarding a particular topic. In particular, search media across stored content and linked content, mark media as favourite for subsequent easy retrieval, filter a search by tags or, in other words, view media by category. The search facility using tags is describe below.

The display 200 of a manager's computer terminal of FIG. 12 illustrates the use of tags in the compliance management system. This is the media window of the compliance management system and is displayed by a user selecting the media tab 27. Documents within the compliance management system may be identified by one or more tags or have one or more tags assigned to them.

To search for related documents by tags, a user or manager clicks in the blank tags search box 300 and starts typing possible tag names, for example, “driver”. A list of matching suggestions from the existing tags (if any) appears. A user clicks on a tag from the list to select it, or the tag may be entered or typed out in full and return pressed. Selected tags appear in the selected tags box 302 below the tags search box 300. In this example, tags “railway” 304 and “station” 306 have previously been selected and these are displayed in the selected tags box 302. This process is repeated to add more tags to the selected tags box. In this example, a match option button 308 displays “Match Any Tag”. In this configuration, selecting search button 310 causes a search to find documents that match any of the tags selected and displayed in the selected tags box 302. To only find documents that have all of the tags in the selected tags box 302, an arrow 312 on the match option button 308 is clicked or selected and an option displaying “Match All Tags” is selected.

Clicking or selecting clear tags button 314 removes all the tags that have been selected and are displayed in the selected tags box 302. Clicking or selecting on remembered tags button 316 restore the tags previously selected and displayed in the selected tags box 302. Clicking or selecting an arrow 318 beside or at the right of the remembered tags button toggles between adding and removing these tags.

A list of all electronic files or information found by the search will be shown in a search results box 320 that, in this example, is to the left hand side of the display 200.

An indicator 322, in this example, at the bottom centre of the search results box 320 indicates how many pages of electronic files there are and which page is currently displayed. Single arrow buttons 324 may be selected to move backwards and forwards between pages. In the example shown, these are grayed out or unselectable as there is only a single page of electronic files. Barred arrow buttons 326 may be selected to move directly to the first or last page. Again, in the example shown, these are grayed out or unselectable as there is only a single page of electronic files.

An indicator 328, in this example, at the bottom right of the search results box 320 indicates how many files there are in total meeting the search criteria and which one is currently displayed.

Clicking or selecting a displayed representation of an electronic file displayed in the search results box 320 cause more information to be displayed about the file in a file information or preview box 330. The preview box, in this example, on the right hand side of the display displays information on the selected file, including: the type of file, for example, a Microsoft Word file, jpeg or pdf 332; the size of the file 334; its associated tags 336; who uploaded it 338; and when it was uploaded 340. The selected file or indication of compliance management information may be located on the Internet and the information may comprise an address on the Internet. The selected file or indication of compliance management information may be at an address on the electronic compliance management storage system.

Clicking or selecting an open button 342 causes the file to open and for it to display on the display 200. An option may be provided to save the file to the computer, if the type of file selected cannot be shown by the computer's browser or other software installed on it. Different tags may be assigned to the same indication of assessment information of the same file, for example, if it is relevant to different tags.

Although not illustrated, acontent provider may upload and link media including metadata and tagging. A content provider may also retire media, that is to say, deprecate/remove media.

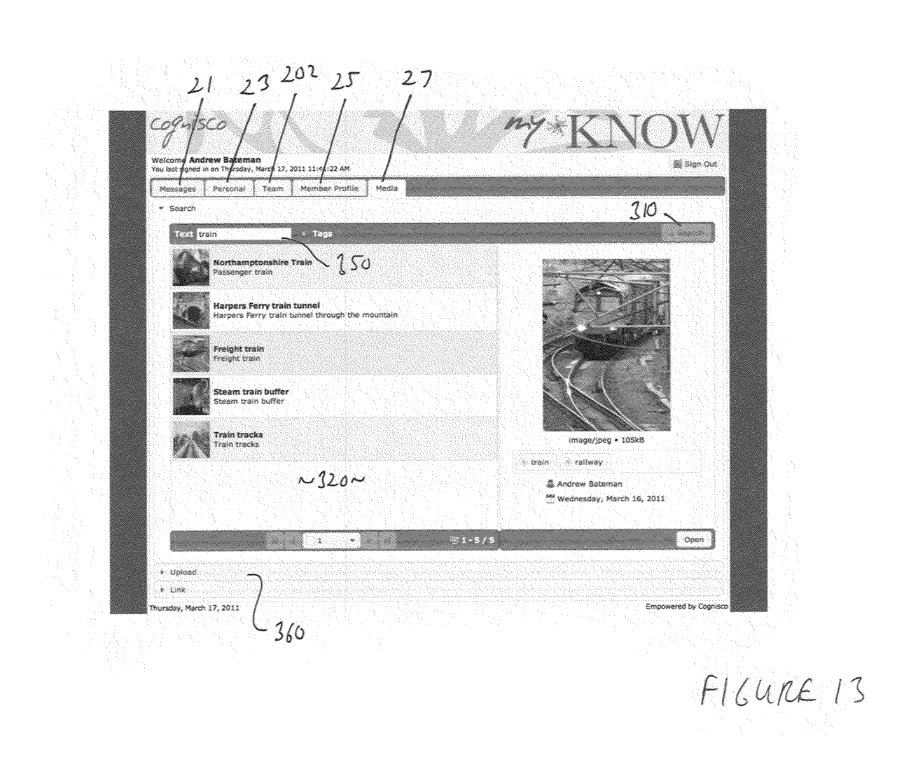

As illustrated in FIG. 13, keyword searching of documents within the compliance management system may be carried out. For this, a text search box is provided. Keyword searching may be carried out by clicking or selecting the box and entering the keyword or text to be searched in the box (in this example, “train”) and pressing return or selecting search button 310. As with tag searching described above, the search results appear in search results box 320 and in all other respects the keyword searching arrangement and tagging search arrangement are the same. A combination of the keyword and tagging searching may be carried out.

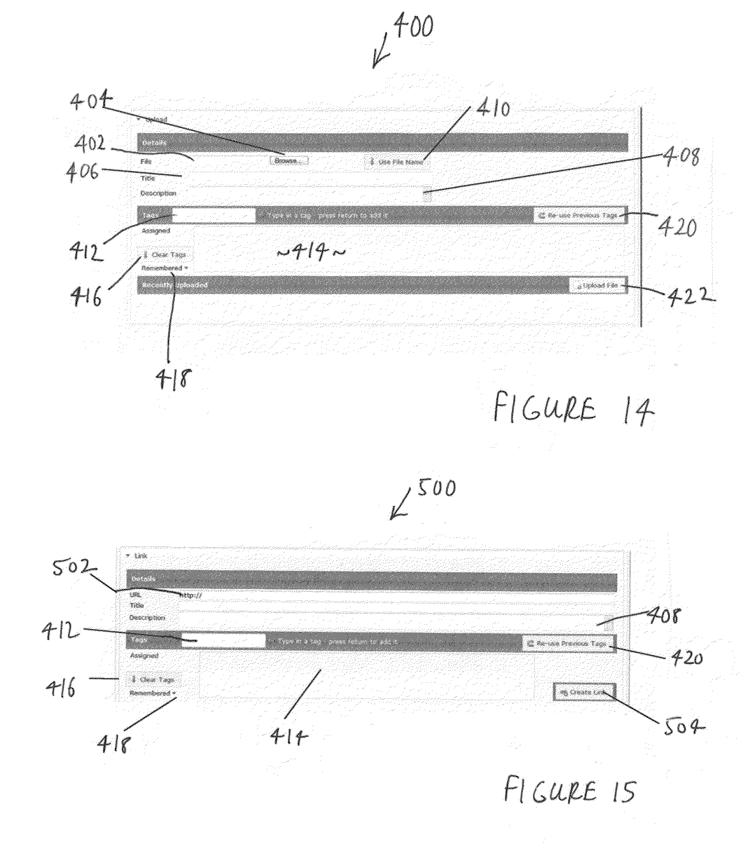

FIG. 14 illustrates the uploading of compliance management information in the form of a file or electronic file into the media library and the adding of one or more tags to the uploaded file or electronic file. To upload a file, the upload file window 400 is opened by selecting or clicking the upload bar 360 under the media tag 27 (sees FIGS. 12 and 13). To select a file for uploading using the upload file window, the name of the file is entered into a file name window 402. Alternatively, browse button 404 may be selected to allow the user to browse files and make a selection. The user may then enter a title and description of the file by clicking or selecting a title box 406 and a description box 408 respectively and entering appropriate text. The name of the file to be uploaded may be entered as the title by selecting or clicking “Use file name” button 410. One or more tags may be assigned to the file by clicking or selecting a tag box 412 and entering the name of a tag in the tag box. Subsequently, pressing return assigns the entered tag name to the file and the tag name appears in an assigned tag window 414. Further tags may be added by repeating the process. A tag may be removed by clicking on it or selecting it. Clicking or selecting “Clear tags” 416 button deletes all the selected tags. Any deleted tags may be restored by clicking “Remembered” button 418 and selecting a tag to restore by selecting it in the window that appears. The selected restored tag appears in the assigned tag window 414.

If more than one file has been selected for uploading, the same tag or tags may be used by selecting or clicking on “Re-use Previous Tags” button 420. Thus, each tag has assigned to it one or more of the indications of compliance management information. To upload the selected file or files, “Upload file” button 422 is selected. The file and the associated tag or tags are stored in a store of the computer system, such as on a hard disk drive or solid state memory.

A similar process may be carried out to add links to compliance management information in the form of websites, web pages, or an address on the Internet to the media library by selecting or clicking link bar 360 under media tag 27 (sees FIGS. 12 and 13) to open link window 500. This window is similar in many respects to the upload file window 400 of FIG. 14 and like features have been given like reference numerals including the features for the addition of tags. In the open link window, a URL or link to a website is entered or cut-and-paste into URL box 502. Tags, title and description are added in the same way as in the upload file window 400 of FIG. 14. To create the link and add it to the media library, “Create link” button 504 is selected or clicked.

An administrators view (not shown) may be provided that allows an administrator to enable and disable user accounts, reset users' passwords, and register users.

The computerized compliance management system may include one, some or all of the features described herein.

Embodiments of the present invention have been described. It will be appreciated that variations and modifications may be made to the described embodiments within the scope of the present invention.

1-16. (canceled)

17. A display for a computerized compliance management system for assessing performance and/or progress of a group, the display comprising:
an indicator comprising a plurality of selectable portions, each portion representing a predetermined range of performance and/or progress levels;
the display being configured such that when one of the plurality of selectable portions is selected the display displays:
an indication of identity of at least some members of the group within the range of the predetermined performance and/or progress level represented by the selectable discrete portion; and
an indication of performance and/or progress of at least one activity carried out by each of the displayed at least some members of the group.

18. A display according to claim 17, wherein each of the plurality of selectable portions have a size dependent on the number of members of the group within the range of the predetermined performance and/or progress level represented by the selectable discrete portion.

19. A display according to claim 17, wherein each of the plurality of selectable portions has a different appearance.

20. A display according to claim 19, wherein the different appearance comprises a different color.

21. A display according to claim 20, wherein the color of one selectable portion comprises red.

22. A display according to claim 20, wherein the color of one selectable portion comprises green.

23. A display according to claim 17, wherein the plurality of selectable portions comprises three or more portions.

24. A display according to claim 23, wherein the plurality of selectable portions comprises three and only three portions.

25. A display according to claim 17, wherein the indication of identity comprises the name of the at least some members of the group.

26. A display according to claim 17, wherein the indication of performance and/or progress of at least one activity carried out by each of the displayed at least some members of the group comprises a graphic.

27. A display according to claim 17, wherein the indication of performance and/or progress comprises at least one from the following list:
unknown or unsure;
not started;
incomplete;
that a user is a risk;
that a user requires additional training;
that a user requires additional supervision;
that assessment has been completed to a standard above that set.

28. An electronic compliance management storage system comprising:
a store arranged to store indications of compliance management information; and
a store arranged to store tags;
wherein each tag has assigned to it one or more of the indications of compliance management information.

29. An electronic compliance management storage system according to claim 28, wherein the indications of compliance management information comprise an address on the Internet.

30. An electronic compliance management storage system according to claim 28, wherein the indications of compliance management information comprise an electronic file.

31. An electronic compliance management storage system according to claim 28, wherein different tags may be assigned to the same indication of compliance management information.

32. A computerized compliance management monitoring system for a group comprising members, wherein the monitoring system comprises:
an entry for each member of the group;
each entry comprising:
an indication of one or more assessments assigned to each member; and
an indication of status of the one or more assessments assigned to each member.

33. A computerized compliance management monitoring system according to claim 32, wherein one or more members may access only their own entry.

34. A computerized compliance management monitoring system according to claim 32, wherein one or more members may access a predetermined set comprising one or more other members entries.

35. A computerized compliance management monitoring system according to claim 32, wherein each entry further comprises a profile including a user's personal data.

36-48. (canceled)
